(19) United States
(12) Patent Application Publication
(10) Pub. No.: US 2003/0030040 A1
(43) Pub. Date: Feb. 13, 2003

(54) Reversibly variable photochromic color composition for articles composed of synthetic resin

(76) Inventors: John Joseph Luthern, Hubbard, OH (US); Victor W. Lee, New Philadelphia, OH (US)

Correspondence Address: HAHN LOESER & PARKS, LLP, TWIN OAKS ESTATE, 1225 W. MARKET STREET, AKRON, OH, 44313, US

(21) Appl. No.: 09/924,868

(22) Filed: Aug. 8, 2001

(51) Int. Cl. G03C 1/00

(52) U.S. Cl. 252/585

(57) ABSTRACT

Disclosed are a reversibly variable color patterning composition for articles made of synthetic resin that include a granulated material containing 1.) at least one reversibly variable photochromic material which is any one of the following or any combination of the following: encapsulated, microencapsulated, or non-encapsulated photochromic dye and 2.) an olefin polymer, copolymer, or terpolymer, the granulated materials not having been subject to a crosslinking reaction.

### TECHNICAL FIELD

The present invention relates to reversibly variable photochromic/non-photochromic color patterning compositions for use in the manufacture of photochromic/non-photochromic patterned synthetic resin articles, methods for producing said reversibly variable photochromic/non-photochromic color patterning composition, and shaped articles having a reversibly variable photochromic/non-photochromic color pattern.

### BACKGROUND

The known technology for producing a colored synthetic polymeric article possessing a pattern consisting of multiple colors includes the procedure of blending two differently colored resins of a different melt viscosity, containing either linearly optical pigment or dye, and molding the two resins in a mutual cavity. Typically, one of these resins is an olefin and the other polymer is a macromolecule incompatible with the olefin. Typical olefin incompatible materials include: polyester, polysulfone, MMA,etc. The colors of the resulting articles are all created by conventional dyes or pigments. Because the dyes and pigments are strictly non-photochromic, they lack marketability and a pleasing aesthetic quality. Also the blending of an olefinic resin with an incompatible resin results in a blend with diminished mechanical properties such as tensile strength, elongation, impact strength and/or other physical properties.

It is known to make a shaped article whose overall color may change with a change in temperature or ultraviolet light exposure. However, no method is known for a method for manufacturing a molded article that changes color reversibly and selectively in the non-crosslinked areas forming the pattern. These articles allow for a wider area of design and an improved marketability.

The object of this invention is to provide a reversibly variable photochromic/non-photochromic color patterning color composition which can be used with advantage for forming figurative or other patterns which change in color reversibly within shaped synthetic polymeric articles.

### SUMMARY

It has now been found that a photochromic color patterning composition may be prepared by blending a polymethylpentene polymer or polymethylpentene copolymer and photochromic material, granulating the resulting blend, and that the resulting blend may overcome the above-mentioned disadvantages of the prior art. This blend can be blended with an olefinic or other synthetic polymer and molded to easily produce a shaped polymeric article which has a color pattern containing said photochromic material. The resulting article has a pattern which reversibly changes color as a result of activating electromagnetic radiation. It has further been found that a microencapsulated photochromic material and/or encapsulated photochromic material demonstrates enhanced sensitivity to activating radiation. Accordingly, when polymethylpentene is used for said color patterning composition and an olefin is used as the background molding resin, the resulting product demonstrates good mechanical properties.

Thus, the present invention provides a photochromic reversibly variable color patterning composition for use in the manufacture of synthetic polymeric articles, several methods for producing said reversibly variable photochromic/non-photochromic color patterning composition and a shaped article having a reversibly photochromic/non-photochromic color pattern, viz.

1. A reversibly variable color patterning composition for synthetic polymeric articles comprising a granulated material containing (i) a polymethylpentene polymer and/or copolymer and (ii) at least one reversibly variable color material containing at least one type of photochromic material, said granulated material not requiring crosslinking at any stage of processing subsequent to the possible microencapsulation or encapsulation of at least one photochromic materials, resulting in a variable photochromic color patterning composition. However, the reversibly variable coloring patterning composition of said invention may be microencapsulated or, encapsulated and subsequently ground into granules of an appropriate size. The size of the ground encapsulated photochromic material is determined by the desired reversible coloring pattern. The larger the size of the ground encapsulated material, the larger the size of the reversibly variable color areas.

2. A method of producing a reversibly variable photochromic/non-photochromic coloring patterning composition by combining at least one reversibly variable color material selected from any type of photochromic materials with a polymethylpentene polymer or copolymer, and granulating the resulting blend. It is not required to subject the granulated material to a crosslinking reaction.

3. A shaped article having a reversibly variable photochromic/non-photochromic color pattern as molded from a composition comprising a polymeric resin and the aforementioned color patterning composition.

The photochromic/non-photochromic color patterning composition of the invention can be produced by combining a photochromic material with a polymethylpentene polymer or copolymer, and granulating the resulting blend. It is not required to subject the granulated material to a crosslinking reaction. This photochromic coloring composition contains no polar materials that would otherwise interfere with the photochromic effect. Because the polymethylpentene polymer or copolymer has a high melt viscosity relative to the olefinic polymer into which it is being blended into, the resulting photochromic/non-photochromic granulated material possesses a high melt viscosity at typical and low ranges of olefinic processing temperature ranges. Therefore, blending this material with various synthetic polymers, especially the olefinic type, and molding the resulting compositions generates synthetic polymeric parts having figurative or other patterns, such as a speckled pattern, marble-like pattern, flow pattern, etc., which reversibly change color in response to available light. The color patterning method employed in the prior art employed a resin incompatible with olefinic polymer, said incompatible polymer usually contains polar groups which may interfere with the photochromic response of the photochromic material. The incompatibility between the two resins also leads to parts or articles possessing inferior mechanical properties.

### DESCRIPTION

The present invention is now described in detail.

Color Patterning Composition

The ingredients of the color patterning composition of the invention are now described.

1. Polymethylpentene Polymer or Copolymer Polymethylpentene comprises 4-methylpentene-1 as a monomeric building block. Polymethylpentene polymer and copolymers possesses high resistance to most organic and inorganic chemicals, which makes it very compatible with photochromic materials as well as light stabilizers that may be blended into the photochromic dye/polymethylpentene to lengthen the photochromic lifetime of the dyes. The polymer and copolymers possess excellent heat resistance, with melting points of approximately 240° C. The transparent grades of polymethylpentene possess a visible light transmittance greater than 90%, which makes this material visibly compatible with other transparent optical thermoplastics such as polystyrene and polyacrylates. This transparency also enhances the photochromic effect. In addition, transparent, translucent, and opaque grades of polymethylpentene are particularly useful in this invention because their transmittance of ultraviolet radiation necessary for the activation of the photochromic material is superior to glass and other commercially available transparent resins. This feature makes the present invention photochromically superior to the blending of thermoplastics with different melt indices to achieve a color patterning effect.

2. Photochromic material The photochromic material which can be used in the present invention includes organic photochromic substances such as dihydopyrene compounds,1,4-2H-oxazine, viologen compounds, spirothiopyran compounds, naphthopyran compounds, triphenylmethane compounds, benzopyran compounds, azobenzene compounds, dithizone metal complex compounds, thioindigo compounds, spirooxazine compounds, spiropyran compounds, and fulgide compounds. Particularly preferred for purposes of the invention are spirooxazine compounds, naphthopyran compounds, fulgide compounds, benzopyran compounds, and spiropyran compounds.

Among specific examples of said photochromic substances are: 6′-indolino-1,3,3-trimethylspiro[indoline-2,3′-(3H)naphtho(2,1-b)(1,4)-oxazine]; spiro[2H-naphtho[2,1-b]pyran-2,2′-tricyclo[3.3.1.13.7]decane]; 1,3,3,-trimethylspiro[indoline-2,3′-(3H)naptho(2,1-b)(1,4)-oxazine]; 5-chloro-1,3,3-trimethylspiro[indoline-2,3′-(3H)naptho(2,1-b)(1,4)-oxazine]; 1,3,5,6-teramethyl-3-ethylspiro[indoline-2,3′-(3H)naphtho(2,1-b)(1,4)-oxazine]; 6′-piperidino-1,3,3-trimethylspiro[indoline-2,3′-(3H)naphtho(2,1-b)(1,4)-oxazine]; 1,3,3,5,6-pentamethylspiro[indoline-2,3′-naphtho(2,1-b)(1,4)-oxazine]; 1,3,5,6-tetramethyl-3-ethylspiroindoline-2,3′-(3H)pyrido(3,2-f)(1,4)-benzoxazine; 1-benzyl-3,3-dimethylspiro[indoline-2,3′-(3H)naphtho(2,1-b)(1,4)-oxazine]; 1,3′,3′-trimethylspiro(2H-2-benzopyran-2,2′-indoline,5,7-dimethylspiro[2H-chromene-2,2′-tricyclo[3.3.1.13.7]decane]; 6-(4-methoxyphenyl)-9-methoxyspiro[2H-naphtho[1,2-b]pyran-2,2′-tricyclo][3.31.13.7]decane]; 6-chlorospiro[2H-naphtho[1,2-b]pyran-2,2′-tricyclo[3.3.1.13.7]decane]; 1,3,3-triphenylspiro[indoline-2,3′-(3H0-naphtho(2,1-b)pyran]; 1-(2-nitrobenzyl)-3,3-dimethylspiro[indoline-2,3′-(3H)naphtho(2,1-b)pyran]; 1-(2,3,4,5,6-pentamethylbenzyl)-3,3-dimethylspiro[indoline-2,3′-(3h)naphtho(2,1-b)pyran]; 2,2-di(p-methoxyphenyl)naphtho(2,1-b)pyran; 2-methyl-5-chlorotrimethylfulgide, 2,5-trimethylfuryltrimethylfulgide; spiro[2H-chromene-2,2′-tricyclo[3.3.1.1 3.7]decane]; among others.

The photochromic material can be used independently; however, for the purposes of increasing the degree of saturation of the color change or for increasing the photochromic lifetime, it is preferable to use simultaneous agents such as plasticizers, hindered amines, hindered phenols, synthetic resins, excited state quenchers, and so on. These materials are well known light stabilizers of photochromic compounds and their concentrations may be selected from well documented ranges. In the present invention, for the purpose of extending the photochromic lifetimes of the photochromic materials, the use of excited state quenchers, hindered amines, hindered phenols, oxetanilides, and other auxilairy agents are recommended.

The hindered phenol compound includes, among others, 4-hydroxymethyl-2,6-di-t-butylphenol; 2,6-di-t-butylphenol; 2,6-di-t-butylphenol; 2,5-di-t-butylhydroquinone; 2,2′-methylene-(4-ethyl-6-t-butylphenol); 2,4,6-tri-t-butylphenol; tetrakis (methylene (3,5-di-t-butyl-4-hydroxycinnamate))methane; 2,4-di-t-butylphenyl-3,5-di-t-butyl-4-hydroxybenzoate; and so on. The excited state quenchers include, among others, nickel-di-butylthiocarbamate; bis(di-n-butyl dithiocarbamato)nickel(II); bis[2,2′-thiobis(4-t-octylphenalato]nickel](II); [2,2′-thiobis[4-(1,1,3,3-tetramethylbutyl)phenolato](butylamine)]nickel; bis[2,2′-thiobis-4-(1,1,3,3-tetramethylbutyl)phenyolato]nickel; and so on. The hindered amine compounds include, among others, bis(2,2,6,6-tetramethyl)-4-piperidyl sebacate; bis(1,2,2,6,6-pentamethyl-4-piperidinyl)sebacate; 8-benzyl-7,7,9,9-tetramethyl-3-octyl-1,3,8-triazaspiro[4.5]undecane-2,4-dione; terais(2,2,6,6-tetramethyl-4-piperidine)butane carbonate; bis(1,2,2,6,6-pentamethyl-4-piperidinyl)-2-(3,5-di-t-butyl-4-hydroxybenzyl)-2-n-butylmalonate; and 1-[2-{3-(3,5-di-t-butyl-4-hydroxyphenyl)propionyloxy}-2,2,6,6-tetramethylpiperidine.

3. Microencapsulation and encapsulation of the reversibly variable color pattern composition. The reversibly variable coloring patterning composition of the present invention may be microencapsulated or encapsulated and subsequently ground, granulated, or processed into granules of an appropriate size. The larger the size of the ground encapsulated material, the larger the size of the reversibly variable color areas in an article fabricated from a polymer composition containing the color patterning composition.

The methods of microencapsulation include but are not limited to the following conventional techniques: interfacial polymerization, in-situ polymerization, in-liquid curing coating, coacervation from an aqueous solution system, coacervation from an organic solution system, melt-dispersing and subsequent cooling, in-gas suspending coating, and spray drying.

All of the aforementioned microencapsulation techniques may be applied to the reversibly variable coloring patterning compositions.

The encapsulation of the photochromic material in a suitable polymeric substrate involves the incorporation of the photochromic material in an oligomeric or monomeric mixture and subsequent polymerization. The resulting solid photochromic polymer is ground into particles of an appropriate size that fit the final desired reversibly variable color pattern design characteristics. Those skilled in the art would be able to produce a reversibly variable photochromic coloring composition with any number or combination of a variety of processing methods based on the information contained in this disclosure.

4. Processing of the Polymethylpentene Polymer or Copolymer and Photochromic material. The granulated material of the present invention invention may be processed by any number of conventional methods. For example, the polymethylpentene and photochromic material may be combined in a V-blender, tumbler, Henschel mixer, extruder, or some other similar mixing apparatus and granulated. Granules in the bead or pellet form can be made by conventional methods such as the hot cutting method, strand cutting method, the underwater cutting method, etc. The term “granulated material” as used herein, where applicable, refers to particles such as beads, pellets an the like. The granulated material of this invention preferably possesses a mean diameter of about 0.01 to 10 mm. The best results are obtained when the mean particle diameter is about 0.1 to 7 mm. Ultimately, the size of the ground encapsulated photochromic material is determined by the desired reversible coloring pattern. The larger the size of the ground encapsulated material, the larger the size of the reversibly variable color areas. The granulated material may possess anywhere from 0.001 to 75 parts by weight of photochromic material to 100 parts by weight of the polymethylpentene polymer or copolymer and preferably about 0.005 to 10 parts by weight of the photochromic material to 100 parts by weight of the polymethylpentene homo or copolymer.

5. Processing Methods to Produce Photochromic Patterned Articles. The photochromic coloring pattern of the invention may be processed by any of the following methods, and the following list is not limiting and only intended to be of illustrative value. Other processing techniques would be obvious to those skilled in the art. The following list illustrates the wide variety of processing techniques available to the composition of this invention, which is an improvement over the existing art. The following processing methods are applicable to the invention: i. Injection molding, with typical temperatures ranging from 150° C. to 330° C., most preferably between 155° C. and 180° C., or at a temperature amenable to thermoplastic processing but below the melting point of the photochromic dye. The pressures encountered during injection molding are sufficiently high to rupture microencapsulated photochromic material. This invention does not absolutely require the utilization of microencapsulated photochromic materials and therefore is an improvement over existing art. ii. Blow molding, which is the process of extruding a molten parison into a closed mold and injecting pressurized air so that the parison expands and conforms to the mold cavity. iii. Extrusion, this color patterning composition can be extruded on ordinary single or twin screw extruders. iv. Rotational molding, which is the process of heating a liquid or powder resin contained in a closed mold in an oven while the mold is spun and flipped simultaneously. v. Thermoforming, which is the process of drawing heated sheet or film into a cool mold whereupon the sheet takes the shape of the inner mold cavity. vi. Paper coating, the material of this invention is suitable for high-speed and thin-layer coating. vii. Rotational molding, which is a process well suited to manufacture complex and simple hollow shapes. The mold is charged with non-photochromic and the photochromic composition of said invention and rotated simultaneously about two axis. As it is heated, the plastic softens and adheres to the inside of the mold surface. The plastic article solidifies upon cooling.No where in the previous art has a color patterning composition demonstrated such processing versatility. This makes this invention all the more commercially viable and unique over the previous art.

In accordance with the above invention, the above photochromic variable color patterning composition is mixed with a synthetic polymer and the resulting blend is molded to produce a product or part that possesses a pattern that reversibly changes color when exposed to radiation of the appropriate wavelength. The appropriate wavelength is characteristic of the particular photochromic dye used in the composition.

The synthetic polymer mentioned above may be any from a wide variety of synthetic thermoplastic resins which includes: polystyrenics, polyesters, polyurethanes, polyamides, ABS, SAN, cellulosics, polycarbonates, acrylics, allylics, acetal polymer and copolymers,vinylic polymers such as polyvinylchloride and polyvinylalcohol, phenolics, and polyolefins. Most preferred is a polyolefin resin. Specific examples of the polyolefins include but are not limited to: low density polyethylene, linear low density polyethylene, medium density polyethylene, high density polyethylene, ultrahigh molecularweight polyethylene, polypropylene, polyallomer, ethylene-propylenecopolymers, and polyethylene-co-vinyl acetate copolymers. Unlike materials utilized in the prior art, the polymethylpentene demonstrates excellent compatibility with all of the aforementioned resins because it is a polyolefin itself. This is an exceptional advantage of the present invention because the resulting molded articles possessing a photochromic coloring pattern have excellent physical properties and do not suffer delamination.

The relative amount of said photochromic color patterning composition to said synthetic polymer is about 0.05 to 50 parts by weight and preferably about 0.1 to 35 parts by weight of photochromic color patterning composition to 100 parts by weight of the synthetic polymer.

Two or more photochromic color patterning compositions can be used in combination. If desired, other additives and fillers such as uv absorbers, light stabilizers, antioxidants, excited state quenchers, dyes, pigments, calcium carbonate, antistat agents, fluorescent pigments, lubricants, flame retardants, blowing agents, thermochromic pigments, etc. can be incorporated. This invention is also unique in the fact that the light stabilizers which increase the lifetime of the photochromic material(s) are incorporated in a matrix that is separate from the matrix that contains the photochromic material(s), i.e., the polymethylpentenepolymer or copolymer. This approach has been found to increase the photochromic lifetime of photochromic materials. Blending of the photochromic color patterning composition may be achieved by any number of techniques including a V-blender, Henschel mixer, tumbler, and other similar methods, as well as blending by hand.

### EXAMPLES

The following examples are intended to describe the invention further and in no way serve to limit the scope of the present invention.

### Example 1

0.5 parts by weight of 1,3,3-trimethylspiro[indoline-2,3-(3H)naphtho(2,1-b)(1,4)-oxazine] i.e.,an organic photochromic compound and 100 parts by weight of polymethylpentene, tradename TPX-DX-820 (Mitsui Petrochemicals Industries, Ltd.) were blended by hand then coextruded through a 2.5 inch NRM extruder. The resulting extruded strand was pelletized. The photochromic granulated material was combined with linear low density polyethylene, Tradename Escorene (Exxon) in the ratio: 5.0 parts by weight of the pellets to 100 parts by weight of the LLDPE. The resulting blend was injection molded into plaques. The plaques appeared similar to natural LLDPE in the absence of uv radiation. However, when exposed to uv light a purple photochromic color appears as an aesthetically pleasing pattern against a background of natural LLDPE color. In the absence of uv, the part reverts back to natural LLDPE color. The color change may be repeated numerous times. The physical properties of the product were similar to a part made from LLDPE alone.

### Example 2

0.5 parts by weight of 1,3,3-trimethylspiro[indoline-2,3-(3H)naphtho(2,1-b)(1,4)-oxazine] i.e.,an organic photochromic compound, and 100 parts by weight of polymethylpentene, tradename TPX DX-820 (Mitsui Petrochemicals Industries, Ltd.) were blended by hand then coextruded through a 2.5 inch NRM single screw extruder. The resulting extruded strand was pelletized. 1.0 parts by weight of 3,3-diphenyl (4-1,b)naphthopyran, i.e., an organic photochromic compound, and 100 parts by weight of polymethylpentene, tradename TPX DX-820 (Mitsui Petrochemicals Industries, Ltd.) were blended by hand then coextruded through a 2.5 inch single screw NRM extruder. The resulting extruded strand was pelletized.

The photochromic granulated material was combined with low density polyethylene, Tradename Escorene (Exxon) in the ratio: 5.0 parts by weight of the photochromic purple pellets and 5.0 parts by weight of the photochromic yellow pellets to 100 parts by weight of the LDPE. The resulting blend was injection molded into plaques. The plaques appeared similar to natural LDPE in the absence of uv radiation. However, when exposed to uv light areas of purple photochromic color and areas of yellow photochromic color appear as an aesthetically pleasing pattern against a background of natural LDPE color. In the absence of uv, the part reverts back to natural LDPE color. The color change may be repeated numerous times. The physical properties of the product were similar to a part made from LDPE alone.

### Example 3

1.0 parts by weight of 3,3-diphenyl (4-1,b)naphthopyran, i.e., an organic photochromic compound, and 100 parts by weight of polymethylpentene, tradename TPX DX-820 (Mitsui Petrochemicals Industries, Ltd.) were blended by hand then extruded through a twin screw Farrell extruder. The resulting strands were pelletized.

The photochromic granulated material was combined with linear low density polyethylene, Tradename Escorene (Exxon) in the ratio: 5.0 partsby weight of the pellets to 100 parts by weight of the LLDPE. In addition, 0.5 parts of tetrakis(methylene(3,5-di-t-butyl-4-hydroxycinnamate))methane and nickel dibutylthiocarbamate, both light stabilizers, were combined with the aforementioned ingredients. The resulting blend was injection molded into plaques. The plaques appeared similar to natural LLDPE in the absence of uv radiation. However, when exposed to uv light a yellow photochromic color appears as an aesthetically pleasing pattern against a background of natural LLDPE color. In the absence of uv, the part reverts back to natural LLDPE color. The color change may be repeated numerous times. The physical properties of the product were similar to a part made from LLDPE alone.

What is claimed is:

1. A reversibly variable photochromic coloring composition comprising:
at least one photochromic compound; and
a polymer or copolymer of 4-methylpentene-1.

2. The reversibly variable photochromic coloring composition of claim 1, wherein said polymer of 4-methylpentene-1 is polymethylpentene.

3. The reversibly variable photochromic coloring composition of claim 1, wherein said at least one photochromic compound is selected from the group consisting of dihydopyrene compounds, 1,4-2H-oxazine, viologen compounds, spirothiopyran compounds, naphthopyran compounds, triphenylmethane compounds, benzopyran compounds, azobenzene compounds, dithizone metal complex compounds, thioindigo compounds, spirooxazine compounds, spiropyran compounds, and fulgide compounds.

4. The reversibly variable photochromic coloring composition of claim 1, wherein said at least one photochromic compound is selected from the group consisting of 6′-indolino-1,3,3-trimethylspiro[indoline-2,3′-(3H)naphtho(2,1-b)(1,4)-oxazine]; spiro[2H-naphtho[2,1-b]pyran-2,2′-tricyclo[3.3.1.13.7]decane]; 1,3,3,-trimethylspiro[indoline-2,3′-(3H)naptho(2,1-b)(1,4)-oxazine]; 5-chloro-1,3,3-trimethylspiro[indoline-2,3′-(3H)naptho(2,1-b)(1,4)-oxazine]; 1,3,5,6-teramethyl-3-ethylspiro[indoline-2,3′-(3H)naphtho(2,1-b)(1,4)-oxazine]; 6′-piperidino-1,3,3-trimethylspiro[indoline-2,3′-(3H)naphtho(2,1-b)(1,4)-oxazine]; 1,3,3,5,6-pentamethylspiro[indoline-2,3′-naphtho(2,1-b)(1,4)-oxazine]; 1,3,5,6-tetramethyl-3-ethylspiroindoline-2,3′-(3H)pyrido(3,2-f)(1,4)-benzoxazine; 1-benzyl-3,3-dimethylspiro[indoline-2,3′-(3H)naphtho(2,1-b)(1,4)-oxazine]; 1,3′,3′-trimethylspiro(2H-2-benzopyran-2,2′-indoline,5,7-dimethylspiro[2H-chromene-2,2′-tricyclo[3.3.1.13.7]decane]; 6-(4-methoxyphenyl)-9-methoxyspiro[2H-naphtho[1,2-b]pyran-2,2′-tricyclo][3.31.13.7]decane]; 6-chlorospiro[2H-naphtho[1,2-b]pyran-2,2′-tricyclo[3.3.1.13.7]decane]; 1,3,3-triphenylspiro[indoline-2,3′-(3H0-naphtho(2,1-b)pyran]; 1-(2-nitrobenzyl)-3,3-dimethylspiro[indoline-2,3′-(3H)naphtho(2,1-b)pyran]; 1-(2,3,4,5,6-pentamethylbenzyl)-3,3-dimethylspiro[indoline-2,3′-(3H)naphtho(2,1-b)pyran]; 2,2-diphenylnaphtho(2,1-b)pyran; 2,2-di(p-methoxyphenyl)naptho(2,1-b)pyran; 2-methyl-5-chlorotrimethylfulgide, 2,5-trimethylfuryltrimethylfulgide; and spiro[2H-chromene-2,2′-tricyclo[3.3.1.13.7]decane].

5. The reversibly variable photochromic coloring composition of claim 1, wherein said composition is not crosslinked.

6. The reversibly variable photochromic coloring composition of claim 1, wherein said photochromic compound is microencapsulated in said polymer or copolymer.

7. The reversibly variable photochromic coloring composition of claim 1, wherein said composition comprises from about 0.001 to about 75 parts by weight of photochromic compound per 100 parts by weight of polymer or copolymer.

8. The reversibly variable photochromic coloring composition of claim 1, wherein said composition comprises from about 0.005 to about 10 parts by weight of photochromic compound per 100 parts by weight of polymer or copolymer.

9. The reversibly variable photochromic coloring composition of claim 1, wherein said composition is in the form of a granulated material with a size of from about 0.01 to about 10 mm.

10. The reversibly variable photochromic coloring composition of claim 1, wherein said composition is in the form of a granulated material with a size of from about 0.1 to about 7 mm.

11. A polymer composition comprising:
a synthetic polymer matrix; and
a reversibly variable photochromic coloring composition, said photochromic coloring composition including:
at least one photochromic compound; and
a polymer or copolymer of 4-methylpentene-1.

12. The polymer composition of claim 11, wherein said synthetic polymer matrix is selected from the group consisting of polystyrenics, polyesters, polyurethanes, polyamides, ABS, SAN, cellulosics, polycarbonates, acrylics, allylics, acetal polymer and copolymers, vinyl polymers, and polyolefins.

13. The polymer composition of claim 11, wherein said synthetic polymer matrix is a polyolefin selected from the group consisting of low density polyethylene, linear low density polyethylene, medium density polyethylene, high density polyethylene, ultra high molecular weight polyethylene, polypropylene, polyallomer, ethylene-propylene copolymers, and polyethylene-co-vinyl acetate copolymers.

14. The polymer composition of claim 11, wherein said polymer of 4-methylpentene-1 is polymethylpentene.

15. The polymer composition of claim 11, wherein said at least one photochromic compound is selected from the group consisting of dihydopyrene compounds, 1,4-2H-oxazine, viologen compounds, spirothiopyran compounds, naphthopyran compounds, triphenylmethane compounds, benzopyran compounds, azobenzene compounds, dithizone metal complex compounds, thioindigo compounds, spirooxazine compounds, spiropyran compounds, and fulgide compounds.

16. The polymer composition of claim 11, wherein said at least one photochromic compound is selected from the group consisting of 6′-indolino-1,3,3-trimethylspiro[indoline-2,3′-(3H)naphtho(2,1-b)(1,4)-oxazine]; spiro[2H-naphtho[2,1-b]pyran-2,2′-tricyclo[3.3.1.13.7]decane]; 1,3,3,-trimethylspiro[indoline-2,3′-(3H)naptho(2,1-b)(1,4)-oxazine]; 5-chloro-1,3,3-trimethylspiro[indoline-2,3′-(3H)naptho(2,1-b)(1,4)-oxazine]; 1,3,5,6-teramethyl-3-ethylspiro[indoline-2,3′-(3H)naphtho(2,1-b)(1,4)-oxazine]; 6′-piperidino-1,3,3-trimethylspiro[indoline-2,3′-(3H)naphtho(2,1-b)(1,4)-oxazine]; 1,3,3,5,6-pentamethylspiro[indoline-2,3′-naphtho(2,1-b)(1,4)-oxazine]; 1,3,5,6-tetramethyl-3-ethylspiroindoline-2,3′-(3H)pyrido(3,2-f)(1,4)-benzoxazine; 1-benzyl-3,3-dimethylspiro[indoline-2,3′-(3H)naphtho(2,1-b)(1,4)-oxazine]; 1,3′,3′-trimethylspiro(2H-2-benzopyran-2,2′-indoline,5,7-dimethylspiro[2H-chromene-2,2′-tricyclo[3.3.1.13.7]decane]; 6-(4-methoxyphenyl)-9-methoxyspiro[2H-naphtho[1,2-b]pyran-2,2′-tricyclo][3.31.13.7]decane]; 6-chlorospiro[2H-naphtho[1,2-b]pyran-2,2′-tricyclo[3.3.1.1 3.7]decane]; 1,3,3-triphenylspiro[indoline-2,3′-(3H0-naphtho(2,1-b)pyran]; 1-(2-nitrobenzyl)-3,3-dimethylspiro[indoline-2,3′-(3H)naphtho(2,1-b)pyran]; 1-(2,3,4,5,6-pentamethylbenzyl)-3,3-dimethylspiro[indoline-2,3′-(3H)naphtho(2,1-b)pyran]; 2,2-diphenyinaphtho(2,1-b)pyran; 2,2-di(p-methoxyphenyl)naphtho(2,1-b)pyran; 2-methyl-5-chlorotrimethylfulgide, 2,5-trimethylfuryltrimethylfulgide; and spiro[2H-chromene-2,2′-tricyclo[3.3.1.13.7]decane].

17. The polymer composition of claim 11, wherein said photochromic coloring composition is not crosslinked.

18. The polymer composition of claim 1, wherein said photochromic compound is microencapsulated in said polymer or copolymer of 4-methylpentene-1.

19. The polymer composition of claim 11, wherein said photochromic coloring composition comprises from about 0.001 to about 75 parts by weight of photochromic compound per 100 parts by weight of polymer or copolymer of 4-methylpentene-1.

20. The polymer composition of claim 11, wherein said photochromic coloring composition comprises from about 0.005 to about 10 parts by weight of photochromic compound per 100 parts by weight of polymer or copolymer of 4-methylpentene-1.

21. The polymer composition of claim 11, further comprising a light stabilizer incorporated into said synthetic polymer matrix.

22. The polymer composition of claim 21, wherein said light stabilizer is selected from the group consisting of excited state quenchers, hindered amines, hindered phenols, and oxetanilides.

23. The polymer composition of claim 11, wherein said polymer composition comprises from about 0.05 parts by weight of said photochromic coloring composition per 100 parts by weight of said synthetic polymer matrix.

24. The polymer composition of claim 11, wherein said polymer composition comprises from about 0.1 parts by weight of said photochromic coloring composition per 100 parts by weight of said synthetic polymer matrix.

25. A shaped article fabricated from the polymer composition of claim 11.

26. The shaped article of claim 25, wherein said article is fabricated by a method selected from the group consisting of injection molding, blow molding, extrusion, rotational molding, thermoforming, and paper coating.

27. A method of producing a reversibly variable photochromic coloring composition, comprising the step of:
combining a photochromic compound with a polymer or copolymer of 4-methylpentene-1.

28. The method of claim 27, wherein said combining step includes microencapsulation of said photochromic compound in said polymer or copolymer of 4-methylpentene-1.

29. The method of claim 27, wherein said combining step includes microencapsulation of said photochromic compound in said polymer or copolymer of 4-methylpentene-1, said microencapsulation carried out by a method selected from the group consisting of interfacial polymerization, in-situ polymerization, in-liquid curing coating, coacervation from an aqueous solution system, coacervation from an organic solution system, melt-dispersing and subsequent cooling, in-gas suspending coating, and spray drying.

30. The method of claim 27, wherein said photochromic coloring composition is not crosslinked.

31. The method of claim 27, further comprising the step of granulating the photochromic coloring composition.

32. The method of claim 27, wherein said combining includes incorporating said photochromic composition in an oligomeric or monomeric mixture of 4-methylpentene-1 and subsequent polymerization of said mixture.

33. The method of claim 27, wherein said combining includes combining the at least one photochromic compound and the polymer or copolymer in a mixing apparatus.

34. The method of claim 33, wherein said mixing apparatus is selected from the group consisting of V-blenders, tumblers, Henschel mixers, and extruders.
